(19) United States
(12) Patent Application Publication
(10) Pub. No.: US 2026/0169696 A1
(43) Pub. Date: Jun. 18, 2026

(54) CONTENT DISTRIBUTION BASED ON AUTOMATICALLY UPDATED USER COST METRICS

(71) Applicant: Google LLC, Mountain View, CA (US)

(72) Inventors: Wenbo Zhang, Mountain View, CA (US); Ehsan Maani, Monte Sereno, CA (US); Sayali Satish Kulkarni, Santa Clara, CA (US)

(21) Appl. No.: 19/375,869

(22) Filed: Oct. 31, 2025

(30) Foreign Application Priority Data
Dec. 13, 2024 (IN) 202411098953

(51) Int. Cl. G06F 7/556

(52) U.S. Cl. CPC G06F 7/556

(57) ABSTRACT

Methods, systems, and apparatus, including computer programs encoded on a computer storage medium, for automated data management. In one aspect, for each candidate digital component in a set of candidate digital components, one or more distribution parameters that control eligibility of the digital component to be distributed to client devices for display to users of the client devices are maintained. For a user of a video platform, a user cost metric for a particular content slot between two videos in a video stream for presentation to the user is obtained. The user cost metric is based on an amount of time since a last digital component was presented to the user in the video stream. A candidate digital component is displayed in the particular content slot based on the user cost metric and the distribution parameters for one or more of the candidate digital components.

### CROSS-REFERENCE TO RELATED APPLICATION

This application claims the benefit of Indian Provisional Application No. 202411098953, filed on December 13, 2024. The disclosure of the prior application is considered part of and is incorporated by reference in the disclosure of this application.

### BACKGROUND

This specification relates to machine learning and automated data management.

The Internet has enabled access to a wide variety of content, e.g., videos, audio, web pages, digital components, etc. For example, a client device can request a video from a video platform by submitting a request to the video platform, and the video platform can identify a video based on the request and then provide the identified video for presentation on the client device, e.g., by streaming the video to the client device.

Short videos have become a popular type of content in recent years. A short video, also known as a “short-form video,” refers to a video with a relatively short duration, i.e., a video that is relatively brief in length. Unlike conventional, long-form videos such as movies, webinars, documentaries, and TV series that are usually longer than 10 minutes, short videos are typically under a few minutes long, with many falling within the 10-60 second range. Short videos are often used in the context of social media platforms where viewers have shorter attention spans and/or prefer quick content consumption.

### SUMMARY

In general, one innovative aspect of the subject matter described in this specification can be embodied in methods that include the actions of: maintaining, for each candidate digital component in a set of candidate digital components, one or more distribution parameters that control eligibility of the digital component to be distributed to client devices for display to users of the client devices; obtaining, for a user of a video platform, a user cost metric for a particular content slot between two videos in a video stream for presentation to the user, wherein the user cost metric is based on an amount of time since a last digital component was presented to the user in the video stream; determining, based on the user cost metric and the distribution parameters for one or more of the candidate digital components, to display a candidate digital component in the particular content slot; selecting, based on the distribution parameters for the one or more candidate digital components, a given candidate digital component; and sending, to a client device of the user, data that initiates presentation of the given candidate digital component to the user in the particular content slot. Other implementations of this aspect include corresponding apparatus, systems, and computer programs, configured to perform the aspects of the methods, encoded on computer storage devices.

These and other embodiments can each optionally include one or more of the following features. The user cost metric can be determined by evaluating an exponential function of time. The exponential function can include parameters that include a starting amplitude of the exponential function, a decay rate of the exponential function, and a minimum value of the exponential function.

The user cost metric for the user of the video platform can be repeatedly determined for each content slot in the video stream.

The parameters included in the exponential function can be updated automatically.

Automatically updating the parameters included in the exponential function can include determining that a condition for updating the parameters included in the exponential function has been satisfied and, in response to the determining, automatically updating the parameters based on user interaction data collected since a preceding time point the parameters were updated. The user interaction data can include, for each of a plurality of users, a respective watch time of the user and a respective acquired amount associated with the user since the preceding time point.

Automatically updating the parameters based on the data can include determining updated values of parameters based on optimizing an objective function that includes a term dependent on the respective acquired amount by using the data.

Determining that the condition for updating the parameters included in the exponential function has been satisfied can include determining that a predetermined amount of time has elapsed since the preceding time point the parameters were updated.

The data may be collected while digital components are presented on the client device in accordance varying values of the parameters.

The varying values can include randomly selected values.

The objective function can be part of a constrained objective problem that includes a constraint. Optimizing the objective function can include optimizing the objective function subject to the constraint. The constraint can be dependent on a maximum number of digital components that can be provided to each client device for display during a fixed amount of time.

The values of the parameters can correspond to a user cohort. Automatically updating the parameters included in the exponential function can include updating values of parameters that correspond to another user cohort in parallel with updating the values of the parameters that correspond to the user cohort.

According to another aspect, there is provided one or more computer-readable storage media encoded with instructions that, when executed by one or more computers, cause the one or more computers to perform the operations of the above method aspects.

According to a further aspect, there is provided a system comprising one or more computers and one or more storage devices storing instructions that when executed by one or more computers cause the one or more computers to perform the respective operations of the above method aspects.

The ways in which the digital components are distributed may differ depending on whether videos are long videos or short videos. For example, digital component may be provided for display during breaks of a single long video. However, this is generally not the case given the relatively short duration of each short video.

Existing cost optimization methods for long-form video platforms are inadequate for short-form video due to inherent differences between the types of videos. Some long-form video methods focus on metrics like view-through-rate, visit-abandonment-rate, which are less relevant in the short-form context. Furthermore, manual optimization processes are too slow and cumbersome to effectively manage the dynamic and high-volume nature of short video content. Thus, solutions for long-form videos may not be suitable for short-form videos and may result in inefficient and/or inaccurate computations of user cost metrics, which can lead to display of videos that frustrate the user, cause the user to stop watching videos, and/or otherwise negatively impact the user experience.

The techniques discussed in this specification can be used to automatically update the user cost metrics that govern how videos and digital components can be distributed to users of a video platform, which can include any system or device that provides videos to client devices. Automatically updating the user cost metrics renders a number of technical benefits, particularly in the cases where the videos are short videos.

For one, a user cost metric would have been needed to be set each time that a new user is added to the video platform. However, repeatedly setting a user cost metric through a manual process for each new user is human labor intensive, time consuming, tedious, and prone to human error, among other deficiencies. Manually setting the user cost metrics, e.g., through a trial-and-error process for each user, also consumes a significant amount of computational and memory resources. In fact, manually setting the user cost metric for each user, or even for each user cohort that includes a group of users, becomes practically infeasible when the user base is large, e.g., when there are one million, two million, ten million, 100s of millions or more users.

By leveraging constrained optimization techniques and user interaction data to automatically determine the user cost metric for each user, the video platform reduces the amount of human labor and the human errors that would otherwise be involved in manually setting the user cost metrics. Moreover, the video platform reduces the amount of computational and memory resources consumed by the user cost metric determination process because setting the user cost metric through a trial-and-error process for each user is no longer required. Instead, user cost metrics can be automatically generated for any user based on user interaction data that characterizes past interaction of the user with the video platform.

For another, the video platform can continuously update the user cost metric for each user so as to ensure that the user cost metric for each user is up-to-date to reflect the most recent video watching experience of the user with the video platform, all without human involvement or intervention. Thus, it becomes possible to adjust the user cost metrics for a large number of users as often as needed, e.g., whenever the video watching behavior of a user has changed. Consequently, by determining whether to provide digital components for display to the user based on the continuously updated user cost metric for the user, not only does the video platform minimize network overhead by eliminating unnecessary data transmissions and reduce power consumption of client devices required for presenting an excessive number of digital components, but the video platform also improve the user experience and maintains long-term user engagement. For example, digital components may only be provided in the right circumstances based on the user cost metric, minimizing the number of digital components selected using computational resources and sent over a network using network resources. This also prevents computationally intensive digital component selection processes from being performed until the right moment at which a user will be more receptive to viewing a digital component, thereby reducing the number of times such a selection process is performed unnecessarily or completely eliminating such unnecessary selection processes.

Using the user cost metrics that are computed automatically as described herein also reduces user frustration caused by the video platform providing too many digital components that may be less relevant to the user than organic videos of the video stream. For example, by updating the user cost metric based on videos watched by the user over a recent time period (e.g., within seconds of the user cost metric being updated) and/or digital components presented to the user during the recent time period, the video platform can make a more accurate determination of the user cost metric given the current video watching experience and make fewer decisions to overload the user with digital components.

Using user cost metrics as described herein also reduces the number of digital component selection processes performed by the video platform or another system that selects digital components for presentation with videos of the video platform. For example, the user cost metric can be used to ensure that showing a digital component at a given point of time, e.g., a given video slot of a video stream, will not frustrate the user prior to triggering a digital component selection process. If the user cost metric will not be at a sufficient value until after the occurrence of several additional video slots, there will be no need for triggering the digital component selection process for those video slots. Thus, the substantial computational resources that go into selecting a digital component for a video slot can be preserved until the user cost metric reaches a value at which the process should be triggered. In some cases, this can prevent the process from being performed at all, e.g., if the user session is short.

The described user cost metric techniques also enable the video platform to evaluate each video slot in a video stream efficiently for placement of a digital component within the video slot. For example, the video platform can quickly and efficiently compute the user cost metric for each video slot and determine whether to trigger the digital component selection process for each video slot.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which a video platform provides videos and digital components for display to client devices.

FIG. 2 is an illustration of an example exponential function of time.

FIG. 3 is a flow chart of an example process of selecting digital components for display at a client device.

FIG. 4 is an illustration of an example video stream.

FIG. 5 is a flow chart of an example process of automatically updating a user cost metric.

FIG. 6 a block diagram of an example computer.

Like reference numbers and designations in the various drawings indicate like elements.

### DETAILED DESCRIPTION

This specification describes techniques for utilizing constrained optimization techniques to update user cost metrics automatically, e.g., without administrative or user interaction. The automatically updated user cost metrics govern how digital components can be distributed for presentation to users of a video platform. Using the automatically updated user cost metrics to govern the distribution of digital components can reduce wasted computing resources that would otherwise be necessary if the distribution of digital components was governed by user cost metrics that are updated through a manual process, e.g., a trial-and-error process.

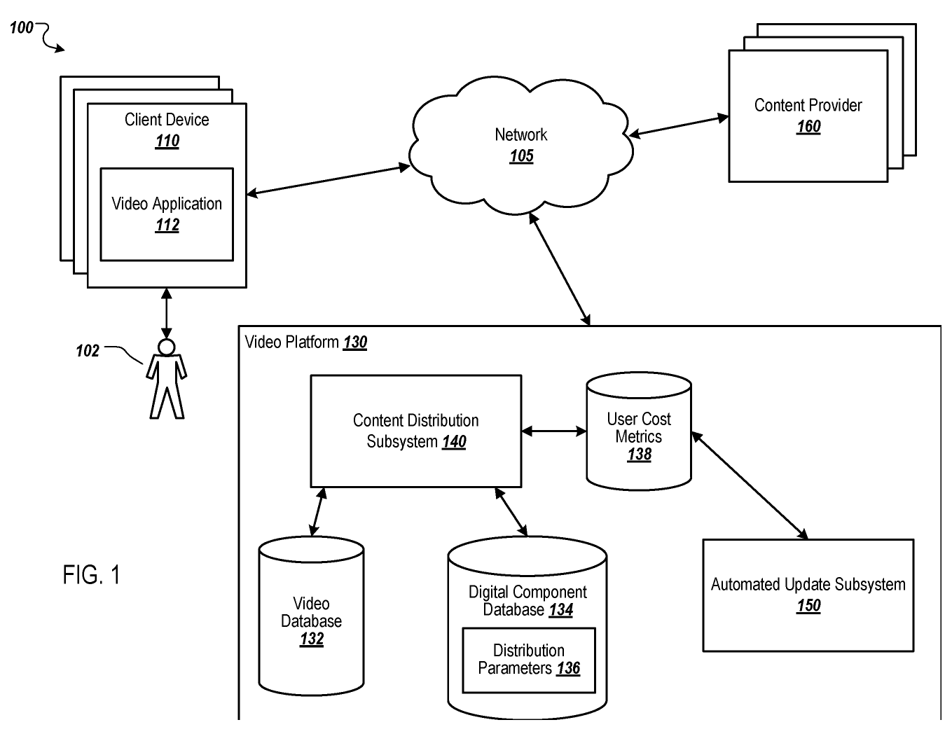

FIG. 1 is a block diagram of an environment 100 in which a video platform 130 provides videos and digital components for display to client devices 110. The example environment 100 includes a data communication network 105, such as a local area network (LAN), a wide area network (WAN), the Internet, a mobile network, or a combination thereof. The network 105 connects client devices 110, the video platform 130, and computing systems of content providers 160. The example environment 100 can include many different client devices 110, video platforms 130, and content providers 160.

A client device 110 is an electronic device that is capable of communicating over the network 105. Example client devices 110 include personal computers, gaming devices, mobile communication devices, e.g., smart phones, digital assistant devices, augmented reality devices, virtual reality devices, and other devices that can send and receive data over the network 105. A client device 110 can also include a digital media device, e.g., a streaming device that plugs into a television or other display to stream videos to the television.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. The digital assistant can be implemented in different forms of hardware devices including, a wearable device (e.g., watch or glasses), a smart phone, a speaker device, a tablet device, or another hardware device. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

A client device 110 typically includes applications, such as web browsers and/or native applications, to facilitate the sending and receiving of data over the network 105. A native application is an application developed for a particular platform or a particular device (e.g., mobile devices having a particular operating system).

The applications include a video application 112, which can be a native application for playing videos, a web browser that plays videos of web pages, or another type of application capable of playing videos. For example, the video application 112 can be a social networking application, video sharing application, video streaming application, video on demand application, chat application, mobile application of a content provider or any combination of such applications.

The video application 112 of a client device 110 can render, display, and/or present content that includes videos to a user 102 of the client device 110. For example, the video application 112 can provide a user interface (e.g., a graphical user interface) to be rendered in a display of the client device 110 for requesting, receiving, searching for, and/or playing videos. The videos include short videos, also known as “short-form videos.” A short video is a video with a duration less than a predetermined maximum duration (e.g., less than 5 minutes, less than 60 seconds, less than 30 seconds, or less than 15 seconds).

In some implementations, the video application 112 can provide online video sharing services to the user 102 over the Internet. That is, the video application 112 can allow the user 102 to create videos, e.g., by using a camera of the client device 110 or another camera, and then upload the videos for sharing with other users. Optionally, prior to uploading the video, the video application 112 allows the user 102 to apply further processing, e.g., video segmentation, merging, and/or encoding, on the video captured by using the camera.

In some implementations, the video application 112 can provide video streaming services to the user 102 over the Internet. That is, the video application 112 can provide a video stream that includes multiple videos for presentation to the user 102. The video stream includes multiple content slots arranged one after another in a given order along a temporal dimension of the video stream (e.g., a video slot, a digital component slot, an audio slot, an image slot, a web feed slot, or the like) for displaying a corresponding content item (e.g., a video, a digital component, an audio clip, an image, a web page, or the like) in the video stream. That is, the video stream can include a sequence of content slots and each content slot can present one or more content items, e.g., one or more videos.

Typically, a video streaming service involves stopping a video in a video stream when the video has ended, and subsequently starting the next video or another content item in the video stream. Thus, with video streaming service, the user 102 of the client device 110 can view multiple videos in a video stream consecutively, one after another in a given order along the temporal dimension. Some video streaming services automatically start the next video after a video has ended. Some video streaming services do not start the next video unless a user initiates the next video to play. Some video streaming services display static information for the next video that is to be played prior to actually playing the next video.

A content provider 160 can create and publish content for display at client devices 110. For example, a content provider 160 can create content for display with videos played at the client devices 110. The content can include digital components that are displayed at the client device 110. A digital component can be displayed at any content slot along the temporal dimension of the video stream. For example, a digital component can be displayed in between two videos in the video stream, e.g., after a video that is being played has ended, and before a next video is played.

As used throughout this document, the phrase “digital component” refers to a discrete unit of digital content or digital information (e.g., a video clip, audio clip, multimedia clip, image, text, or another unit of content). A digital component can electronically be stored in a physical memory device as a single file or in a collection of files, and digital components can take the form of video files, audio files, multimedia files, image files, or text files and include advertising information, such that an advertisement is a type of digital component.

For example, the digital component may be content that is intended to supplement content of a video or other resource displayed by the video application 112. More specifically, the digital component may include digital content that is relevant to the content (e.g., the digital component may relate to the same topic as a video played before or to be played after the digital component, or to a related topic). The provision of digital components can thus supplement, and generally enhance, the video or application content.

The video platform 130 provides content that includes videos and digital components for display at the client devices 110. The videos can be stored in a video database 132. The video database 132 can be implemented on one or more storage devices, e.g., one or more hard drives, flash memory, etc., that is accessible by the video platform 130. The digital components can be stored or at least indexed in a digital component database 134. The digital component database 134 can likewise be implemented on one or more storage devices, e.g., one or more hard drives, flash memory, etc., that is accessible by video platform 130.

In some implementations, the digital components are stored by the content providers 160. In such examples, the video platform 130 can request or cause the client device 110 to request a selected digital component for presentation in a content slot from a content provider 160 that distributes the selected digital component. For example, the video platform 130 can provide, to the client device 110, a resource locator (e.g., a Universal Resource Locator (URL) or Universal Resource Identifier (URI)) for a network location from which the selected digital component can be downloaded.

In practice, there may be a large number, e.g., thousands or millions or more of, digital components that are stored in the digital component database 134. The large number of available digital components can be indexed in the digital component database 134. For example, the digital component database 134 can include multiple digital component index entries, where each digital component index entry can reference the corresponding digital component and/or include distribution parameters 136 that contribute to (e.g., trigger, condition, or limit) the distribution/transmission of the corresponding digital component by the video platform 130.

Generally, the distribution parameters 136 control eligibility of the digital component to be distributed to client devices 110 for display to users 102 of the client devices 110. The distribution parameters 136 for a digital component include a selection value. A selection value represents an amount (e.g., a monetary amount) that a component provider 160 is willing to provide to another entity in exchange for the digital component being presented for display to a user 102. For example, the entity can be an organization that runs the video platform 130. As another example, the entity can be a publisher of a video, e.g., a user who uploaded the video for sharing.

In some implementations, the distribution parameters 136 for a particular digital component can also include distribution keywords that must be matched (e.g., by terms specified in the request for a video or as a topic of a video in the video stream such as a video being played directly before or after the digital component) in order for the digital component to be eligible for presentation. Additionally, or alternatively, the distribution parameters 136 can include embeddings that can use various different dimensions of data, such as video details and/or viewing details (e.g., window size, video playback speed, topic of a video in the video stream, topics of multiple videos in the video stream, or other information about the user viewing of video). The distribution parameters 136 can also require that the request for a video include information specifying a particular geographic region (e.g., country or state) and/or information specifying that the request for a video include originated at a particular type of client device (e.g., mobile device or tablet device) in order for the digital component to be eligible for presentation. The distribution parameters 136 can also specify an eligibility value (e.g., ranking score, or some other specified value) that is used for evaluating the eligibility of the digital component for distribution/transmission (e.g., among other available digital components).

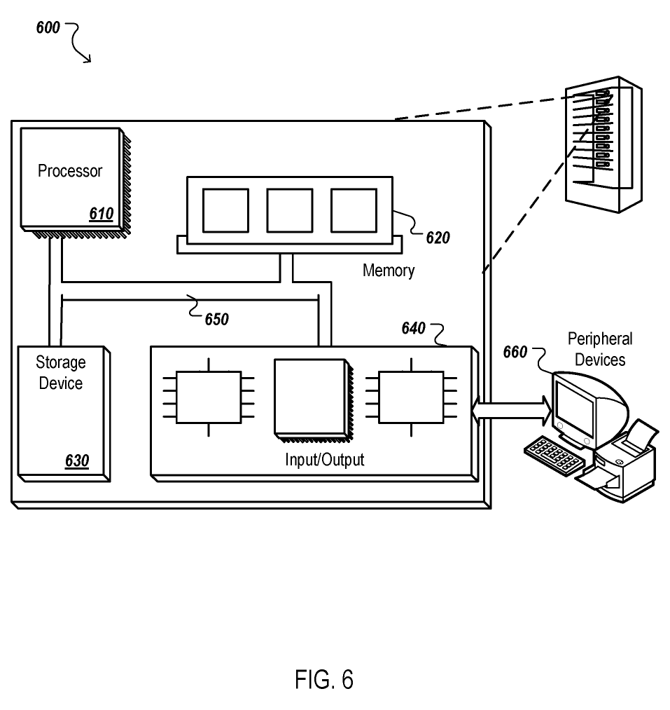

The video platform 130 includes a content distribution subsystem 140 and an automated update subsystem 150. Each subsystem 140, 150 can be implemented using one or more computer systems, e.g., the computer system 600 of FIG. 6. Although FIG. 1 shows the automated update subsystem 150 as part of the video platform 130, in various implementations, the automated update subsystem 150 can be part of a separate system and/or operated by a different party than the video platform 130.

In some implementations, the video platform 130 is an online video sharing platform that operates together with the video applications 112 to provide online video sharing service to the users 102 over the Internet. For example, the videos stored in the video database 132 can include videos created by users and uploaded to the video platform 130 through the video applications 112 that run on the client devices 110.

In some implementations, the video platform 130 is a video streaming platform that operates together with the video applications 112 to provide video streaming service to the users 102 over the Internet. That is, the video platform 130 can provide a video stream that includes multiple videos for presentation to the user 102 through the video application 112. When also implemented as an online video sharing platform, the multiple videos included in the video stream that is provided by the video platform 130 can include videos that have been created and uploaded by various other users.

The content distribution subsystem 140 can provide videos for display at the client devices 110. In some implementations, the content distribution subsystem 140 can receive a request for a video (or a video stream) from the video application 112, select a video from the video database 132 based on the request, and provide the selected video (e.g., as part of the video stream) to the video application 112 in response to the receiving the request over the network 105.

For example, in these implementations, the content distribution subsystem 140 can select the video based at least in part on information included in or associated with the request. For example, this selection can be based on a title of the video, a brief description of the content of the video, or another index of the video, e.g., a textual index such as one or more keywords, a graphical index such as a preview image of the video, or a multi-modal index that includes one or more keywords and a preview image.

In some implementations, a user 102 can interact with a video control user interface element of the video application 112 that enables the user 102 to start a video streaming service, e.g., by selecting a play control, and the content distribution subsystem 140 can begin providing a video stream that includes multiple videos for presentation to the user 102 through the video applications 112. In some of these implementations, the user can navigate through the multiple videos included in the video stream by swiping (or dragging) up or down to skip a video. In some of these implementations, the user can swipe (or drag) left or right to “fast forward” or “rewind” a video.

For example, in these implementations, the content distribution subsystem 140 can select a video for each content slot included in the video stream based at least in part on information associated with prior interactions of the user 102 (or another user) with the video application 112 (or another video application), e.g., information about which videos that the user has previously viewed, fast forwarded, rewound, or skipped. Additionally or alternatively, the content distribution subsystem 140 can select a video for each content slot included in the video stream based at least in part on how the videos are created, e.g., the content distribution subsystem 140 can select, for consecutive content slots included in a video stream, videos that are uploaded by the same or distinct users.

In addition to providing videos for display at client devices 110, the content distribution subsystem 140 also provides digital components for display at the client devices 110. For example, the content distribution subsystem 140 can display a digital component after (or before) a video that has been selected in response to a request is displayed. As another example, the content distribution server 140 can display a digital component in between two videos in a video stream, e.g., after a video that is being played has ended, and before a next video is played. As described above, the digital component can also be a video.

The presentation of the digital component can be based on the distribution parameters 136 that control eligibility of the digital component to be distributed to client devices 110 and that are stored in association with the digital components in the digital component database 134. The presentation of the digital components is also based on user cost metrics 138 for the users 102. Generally, the content distribution subsystem 140 maintains different user cost metrics 138 for different users 102. For example, a first user cost metric for a first user may be different from a second user cost metric for a second user.

For each user 102, the user cost metric 138 can include or represent a minimum selection value for any digital component. That is, the user cost metric 138 can indicate a minimum selection value that a digital component must have in order for a digital component to be presented to the user. Hence, the user cost metric 138 may also be referred to as the “floor selection value.” In another example, the user cost metric can be a value that is applied to a base selection value (e.g., by multiplying the user cost metric by the base selection value) to obtain the minimum selection value. For each user 102, in order for any digital component stored in the digital component database 134 to be eligible for presentation to the user, the digital component is required to have a selection value (as one of the distribution parameters for the digital component) that is no smaller than the minimum selection value included in, or represented by, the user cost metric 138 for the user 102.

For each user 102, the user cost metric 138 is a dynamic value that is adjusted over time, e.g., increased or decreased throughout a period of time spanned by a video stream that is being presented to the user 102. In particular, in some implementations, for each user 102, the content distribution subsystem 140 can determine the user cost metric 138 based on evaluating a function based on the amount of time since the last digital component was presented to a user 102 in a video stream, or alternatively since the beginning of the video stream.

Such a function can be any function that has, or is based on, parameters (also referred to constants) and variables (e.g., a time variable that is dependent the amount of time since the last digital component was presented, and possibly other variables) and that can be used by the content distribution subsystem 140 to compute an output that defines the user cost metric 138.

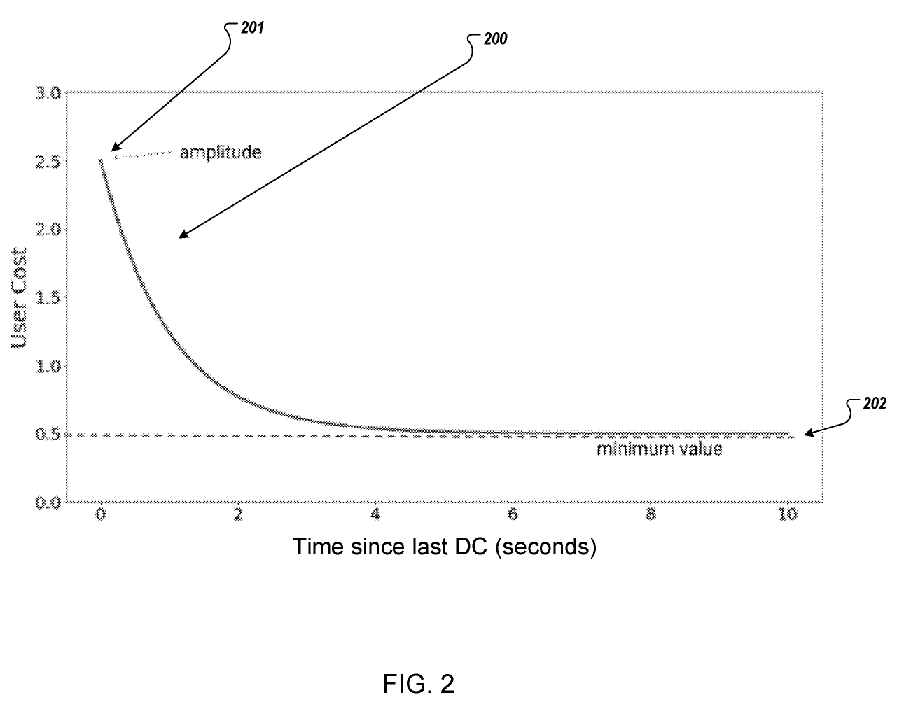

Merely as an example, the function can be an exponential function 200 of time as illustrated in FIG. 2. The exponential function 200 can be used by the content distribution subsystem 140 to compute a user cost metric for a user. The user cost metric includes a minimum selection value that is dependent on an amount of time since the last digital component was presented to the user in a video stream rather than an organic video of the video stream.

In FIG. 2, the horizontal axis represents time (and more specifically an amount of time since the last digital component was presented to the user in a video stream), and the vertical axis represents the user cost metric (and more specifically the minimum selection value). The exponential function is based on a total of three parameters: a first parameter that defines a starting amplitude 201 of the exponential function (illustrated in FIG. 2 as the leftmost starting point of the exponential function), a second parameter that defines a decay rate of the exponential function, and a third parameter that defines a minimum value 202 of the exponential function (illustrated in FIG. 2 as the horizontal asymptote of the exponential function).

In practice, as the parameters of the exponential function are updated, the shape of the exponential function will also change. Accordingly, the user cost metric that can be computed using the exponential function for a same time point along the horizontal axis will also change. For example, suppose that the parameters are updated to cause the exponential function to approach the minimum value at a greater descending rate, then a user cost metric computed using the updated exponential function at 2 seconds after the last digital component was presented to the user in the video stream will be smaller than a user cost metric computed using the previous exponential function at 2 seconds after the last digital component was presented to the user in the video stream.

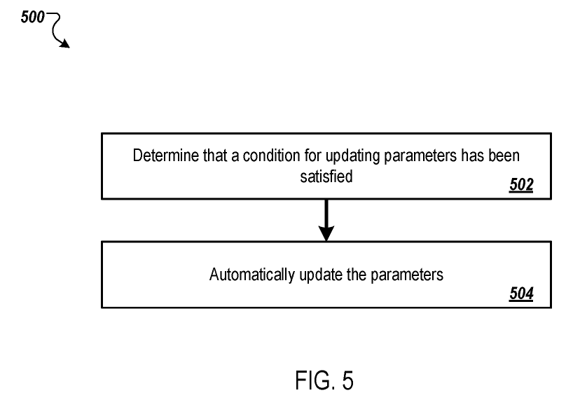

The parameters of the exponential function can be determined based on user interaction data, as described with reference to FIG. 5. For example, the parameters of the exponential function can be determined using constraint optimization, as described with reference to FIG. 5.

More generally, in some implementations, for each user 102, the content distribution subsystem 140 can include a machine learning model that has parameters and that can be used to determine the user cost metric 138.

Such a machine learning model can be configured (e.g., trained) to receive an input to the machine learning model that includes data defining the amount of time since the last digital component was presented to a user 102 in a video stream, or alternatively since the beginning of the video stream, and possibly other data, and to process the input in accordance with the parameters of the machine learning model to generate an output that defines the user cost metric 138. For example, the machine learning model can be one of: a neural network, a decision tree model, a random forest model, a gradient boosting model, a linear regression model, a logistical regression model, a support vector machine (SVM) model, to name just a few.

In particular, the automated update subsystem 150 is configured to repeatedly update the user cost metrics 138 in an automatic manner, e.g., without administrative or user interaction. In this manner, the video platform 130 can use the content distribution subsystem 140 to automatically select either a video (e.g., an organic video) or a digital component for each content slot included in a video stream that is being presented to a user 102, and use the automated update subsystem 150 to automatically update the user cost metrics 138 that can be used by the content distribution subsystem 140 to make this selection for each content slot.

For example, some implementations of the automated update subsystem 150 can periodically update the parameters of the function, e.g., the first, second, third parameters of the exponential function in the example of FIG. 2, that is used to compute the user cost metric 138 for each user 102, based on user interaction data collected since a preceding time point the parameters were updated, so as to ensure that the user cost metric 138 for each user 102 is up-to-date to reflect the most recent video viewing experience of the user 102. As will be discussed further below with reference to FIG. 5, the user interaction data characterizes the interaction of the user with the video platform 130 since the preceding time point.

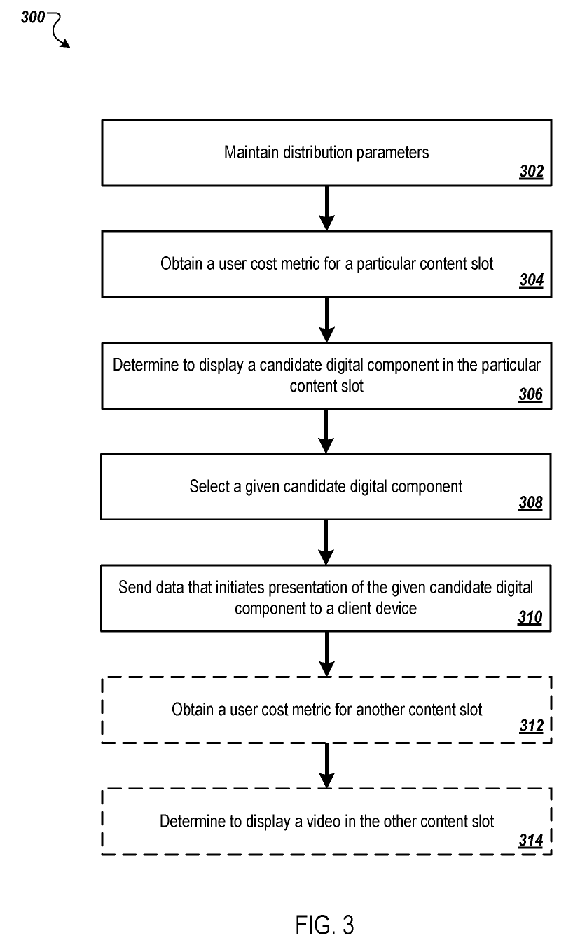

FIG. 3 is a flow chart of an example process 300 of selecting digital components for display at a client device. Operations of the process 300 can be performed, for example, by the video platform 130 of FIG. 1, or another data processing apparatus. The operations of the process 300 can also be implemented as instructions stored on a computer readable medium, which can be non-transitory. Execution of the instructions, by one or more data processing apparatus, causes the one or more data processing apparatus to perform operations of the process 300.

The video platform can provide video streaming service to users over the Internet. For example, the video platform can provide a video stream that includes multiple videos for presentation to a user of the client device. These videos can also be referred to as organic videos. The video stream includes multiple content slots arranged one after another in a given order along a temporal dimension of the video stream for displaying a corresponding content item (e.g., organic video or a digital component) in the video stream.

The video platform maintains, for each candidate digital component in a set of candidate digital components that are available for display to the client device, one or more distribution parameters (302). The set of candidate digital components can be stored in a digital component database that is accessible by the video platform. Each candidate digital component in the set can be stored in association with one or more distribution parameters that corresponds to the candidate digital component.

For each candidate digital component, the one or more distribution parameters control eligibility of the digital component to be distributed to the client device for display to the user of the client device. For example, as previously mentioned, the one or more distribution parameters for a digital component include at least a selection value for the digital component which represents an amount (e.g., a monetary amount) that a component provider is willing to provide to another entity in exchange for the digital component being presented for display to a user.

The video platform obtains a user cost metric for a user of the video platform for a particular content slot in the video stream (304). As previously mentioned, the user cost metric includes or represents a minimum selection value for any digital component. In some implementations, the video platform can repeatedly obtain a user cost metric for each content slot in the video stream. That is, the user cost metric for each content slot can differ, e.g., based on the amount of time between the last presentation of a digital component and the content slot.

For example, the user may be viewing a video in the video stream, and the video platform can determine the user cost metric as the user is viewing the video in the video stream. Then, the video platform can determine, based on the determined user cost metric, whether to present a video or a digital component in a next content slot in the video stream that follows the content slot occupied by the video currently being viewed by the user. The video platform can do this for multiple content slots following the content slot occupied by the video currently being viewed by the user.

In some implementations, for the particular content slot, the video platform can determine the user cost metric by evaluating a function based on the amount of time since the last digital component was presented to the user in the video stream, or alternatively since the beginning of the video stream. For example, the function can be an exponential function of time as described with reference to FIG. 2. If a digital component was previously presented to the user within the video stream, then the amount of time can be counted starting from the time point where that digital component was presented. If the digital component is a video, the time point for the video can be the time point at which the video digital component started playing, the time point at which the video digital component stopped playing, or a time point halfway through the video digital component. Alternatively, if no digital component was previously presented, the amount of time can be counted starting from the beginning of the video stream.

Generally, the video platform maintains different user cost metrics for different users. In some implementations, the video platform maintains different user cost metrics for different user cohorts. Each user cohort includes multiple users sharing one or more common attributes. For example, a user cohort can include users of a given age range that are determined to be interested in a given topic. In these implementations, the user cost metrics for the multiple users included in the same user cohort can be the same. For example, each user cohort can include multiple users sharing a common geographic attribute, e.g., that are located within a common location. The multiple users can be grouped into user cohorts based on other attributes.

For each user, the user cost metric is a dynamic value that is automatically updated over time without administrative or user interaction, e.g., increased or decreased throughout a period of time spanned by the video stream that is being presented to the user. For example, the parameters included in the function or in the machine learning model that can be used to determine the user cost metric can be automatically updated over time, as will be discussed further below with reference to FIG. 5. In this manner, the user cost metric that is determined for a preceding content slot may be different from the user cost metric that is determined for a subsequent content slot within the same video stream that is being presented to the same user.

The video platform determines, based on the user cost metric and the distribution parameters for one or more of the candidate digital components, to display a candidate digital component in the particular content slot for presentation to the user (306). In other words, the video platform determines that a digital component should occupy the particular content slot in the video stream. For example, the particular content slot can correspond to the next content slot in the video stream that follows the content slot occupied by the video currently being viewed by the user.

In practice, the video platform can compare the minimum selection value of the user cost metric that has been obtained in operation 304 to the selection value that is included as one of the distribution parameters for each of one or more of the candidate digital components. Accordingly, the determination to display the candidate digital component (and rather than a video, e.g., a video that is stored in the video database) in the particular content slot for presentation to the user can be then made by the video platform in response to determining that, for at least one of the one or more candidate components, the selection value which is included as one of the distribution parameters for the candidate components is greater than or equal to the minimum selection value. That is, at least one digital component has a selection value that meets or exceeds the minimum selection value represented by the user cost function for the particular content slot.

In some implementations, the video platform can trigger the selection of a digital component when the user cost metric satisfies a threshold, e.g., is at or below the threshold. This threshold can be based on the selection values of candidate digital components, or the threshold can be a value independent of the selection values of the candidate digital components. In one example, the threshold can be set to ensure that at least a threshold number of candidate digital components are eligible, e.g., have a selection value that meets or exceeds the threshold user cost metric.

The video platform selects, based on the distribution parameters for the one or more candidate digital components, a given candidate digital component from among the one or more candidate digital components (308). There are many ways in which the video platform can make this selection of the given candidate digital component.

For example, when the distribution parameters for a candidate digital component include distribution keywords, the selection of the given candidate digital component can be made based on determining whether there exists an exact or approximate match between the distribution keywords and the terms specified in the request for a video stream. Other ways of making this determination are possible, depending on the exact distribution parameters that are stored in association with the candidate digital components in the digital components database.

The video platform sends, to the client device of the user, data that initiates presentation of the given candidate digital component to the user in the particular content slot over a network (310). The transmission of the data triggers (a video application running on) the client device to display the given candidate digital component in the particular content slot. For example, the data sent by the video platform can include the given candidate digital component, or an identifier that can be used by the client device to retrieve the given candidate digital component.

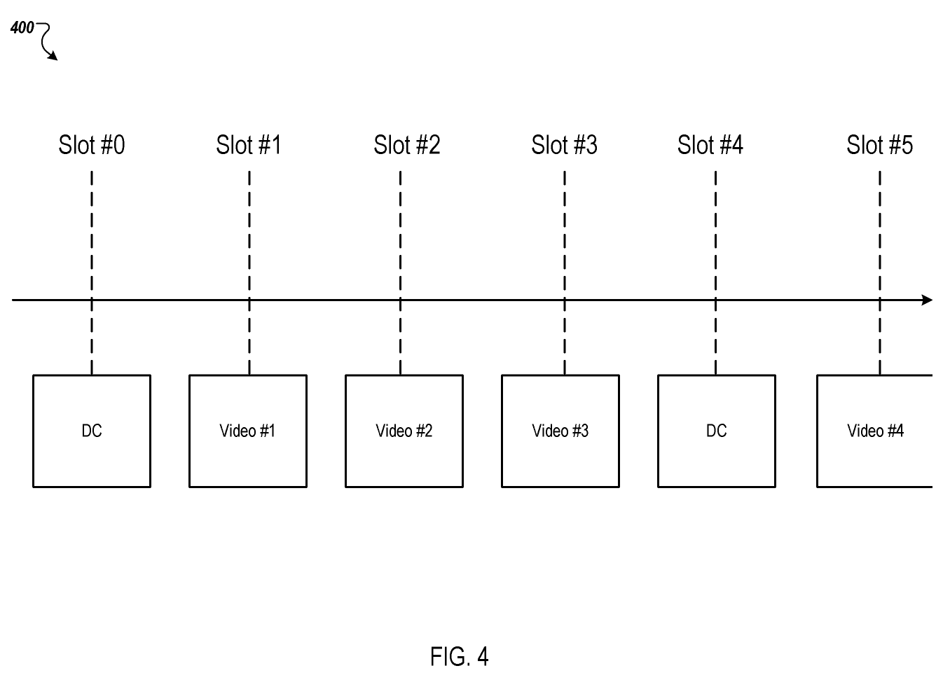

FIG. 4 is an illustration of an example video stream 400 that is being provided by the video platform for presentation on the client device. The horizontal axis in FIG. 4 represents time. The video stream 400 includes a total of six content slots (slot #0 – slot #5).

Suppose that the particular content slot corresponds to slot #4 in the video stream 400 of FIG. 4. As the user is watching video #3 that occupies slot #3 within the video stream 400, the video platform can obtain the user cost metric for content slot #4, and then determine to display a given candidate digital component in content slot #4 for presentation to the user based on the user cost metric and the distribution parameters for one or more of the candidate digital components.

Accordingly, the video platform sends data to the client device that, as illustrated in FIG. 4, triggers the video application running on the client device to display the given candidate digital component for presentation to the user of the client device in slot #4. That is, the video application stops video #3 in the video stream when video #3 has ended, and subsequently starts the given candidate digital component in the video stream. In this manner, the next content item that the user will watch while watching the video stream following video #3 will be the given candidate digital component.

Optionally, the process 300 further includes the following operations.

The video platform obtains a user cost metric for a user of the video platform for another content slot in the video stream that is after the particular content slot (312). Much like in operation 306, in some implementations, the video platform can determine the user cost metric by evaluating a function of time, e.g., the exponential function of time as described with reference to FIG. 2.

In some cases, the parameters included in the function or in the machine learning model have not been updated since the function was used to determine the user cost metric as part of operation 304. However, in other cases, the parameters included in the function or in the machine learning model are updated at least once since the same function was used to determine the user cost metric as part of operation 304, and hence the values of the parameters used by the video platform to determine the user cost metric in operation 312 are different than the values of parameters used by the video platform to determine the user cost metric in operation 312.

The video platform determines, based on the user cost metric and the distribution parameters for one or more of the candidate digital components, to display a video in the other content slot for presentation to the user, and in response, sends data that initiates presentation of the video to the user in the other content slot to the client device of the user over the network (314). For example, the video can be a short video that is stored in the video database and that is selected by the video platform using any of the example ways mentioned above with reference to FIG. 1.

In practice, the video platform can compare the minimum selection value included in the user cost metric that has been obtained in operation 312 to the selection value that is included as one of the distribution parameters for each of one or more of the candidate digital components. Accordingly, the determination to display the video candidate digital component (and rather than a digital component) in the other content slot for presentation to the user can be then made by the video platform in response to determining that, for each of the one or more candidate components, the selection value which is included as one of the distribution parameters for the candidate components is less than the minimum selection value.

This can be because that the minimum selection value has increased by certain amount, as a result of the automatic update to the user cost metric (e.g., as a result of the automatic update to the parameters included in the function or in the machine learning model that can be used to determine the user cost metric) for the user, for example.

Turning back to the FIG. 4, suppose that the other content slot corresponds to slot #5, which immediately follows slot #4 in the video stream 400. The video application stops the given candidate digital component that occupies slot #4 in the video stream 400 when the given candidate digital component has ended, and subsequently starts video #4 in the video stream. In this manner, the next content item that the user will watch while watching the video stream following the given candidate digital component will be video #4.

As can be seen in FIG. 4, when providing a video stream for presentation to a user as part of the provision of the video streaming service, the video platform can usually provide a digital component for presentation in between two videos in the video stream, e.g., after a first video but before a second video. Further, because the user cost metric is continuously updated over time, the digital components could be interleaved between varying numbers of videos in the video stream. Still further, because the videos included in the video stream include short videos, the video platform refrains from providing any digital component for presentation in between any single video, e.g., the video platform does not break a single video to provide a digital component for presentation in between the breaks during the single video.

FIG. 5 is a flow chart of an example process 500 of automatically updating a user cost metric. Operations of the process 500 can be performed, for example, by the video platform 130 of FIG. 1, or another data processing apparatus. The operations of the process 500 can also be implemented as instructions stored on a computer readable medium, which can be non-transitory. Execution of the instructions, by one or more data processing apparatus, causes the one or more data processing apparatus to perform operations of the process 500. Notably, operations of the process 500 can be performed automatically, without administrative or user interaction.

In general, iterations of the process 500 can be repeated for each of one or more users of the video platform to update the values of parameters included in the function or in the machine learning model that can be used to determine the user cost metric for the user. In some implementations where the different users are grouped into user cohorts, iterations of the process 500 can be repeated for each different user cohort to update the values of parameters included in the function or in the machine learning model that can be used to determine the user cost metric for the user cohort. Each user cohort includes multiple users sharing one or more common attributes. For example, the users can be grouped into cohorts based on similarities between the users where similar users have common or similar attributes.

In some implementations, the video platform can parallelize the iterations of the process 500 for different users (or, analogously, different user cohorts) across multiple computers to reduce the overall time needed to update the user cost metrics for the users. The multiple computers can update values of parameters that correspond respectively to different users (or, analogously, different user cohorts) in parallel with each other.

For each user (or, analogously, for each user cohort), iterations of the process 500 can be repeated as often as necessary to generate the up-to-date values of parameters included in the function or in the machine learning model based on the most recent video watching experience of the user (or, analogously, the users in the user cohort) with the video platform.

The video platform determines that a condition for updating the parameters has been satisfied (502). In some implementations, the parameters can be parameters of a function. For example, the function can be the exponential function of time as described with reference to FIG. 2. More generally, the function can be any function that has parameters (also referred to constants) and variables (e.g., a time variable that is dependent the amount of time since the last digital component was presented, and possibly other variables). In some other implementations, the parameters can be parameters included in a machine learning model.

There are many ways that the video platform can determine whether the condition has been satisfied. For example, the video platform can determine that a predetermined amount of time, e.g., 10 seconds, a minute, an hour, a day, a week, or a month, has elapsed since the parameters were updated. As another example in which the parameters are for the user cost metric for a user cohort, the video platform can determine that a total number of the users included in the user cohort has changed, e.g., increased or decreased, or changed by a threshold amount, e.g., a threshold number of users added to or removed from the cohort. As yet another example, the video platform can determine that the parameters should be updated upon receiving an instruction from another system. As yet another example, the video platform can determine that the parameters should be updated in response to an event, e.g., that the video stream has progressed to the next content slot (e.g., in response to a video completing or the user skipping the video) or a digital component has been presented to the user in a content slot of the video stream. In another example, the event that triggers the update to the user const metric for a particular content slot can be a determination that there are a threshold number of content slots between the content slot for a video being presented to the user and the particular content slot. For example, if there are three or fewer content slots between the current content slot and the particular content slot, the video platform can determine to update the parameters that are used to compute the user cost metric for that content slot.

In response, the video platform automatically updates the parameters, i.e., determines the updated values of the parameters, based on user interaction data collected since a preceding time point the parameters were updated (504). The parameters are then used to determine an update user cost metric for one or more content slots of a video stream. The user interaction data characterizes past interaction of the user (or, analogously, the users in the user cohort) with the video platform.

The user interaction data can include, for the user (or, analogously, for each of multiple users in the user cohort), a watch time of the user since the preceding time point. The watch time can represent an amount of time the user has spent watching videos in a video stream. For example, the watch time can be the total amount of time that the user has watched videos in the video stream during a current session. The session can start when the user opens an application to view videos, when a first video in the video stream starts to play, or when activity with the video stream (e.g., initiating the playing of a video) resumes after a break in activity (e.g., at least a threshold amount of time has passed from the time at which a last video was watched and a current video was started).

In addition, the user interaction data can include, for the user (or, analogously, for each of multiple users in the user cohort), an acquired amount associated with the user (or, analogously, for each of multiple users in the user cohort) while the user is watching videos in the video stream. The acquired amount can represent an amount that has been received (or is expected to be received) from the content providers for presentation of digital components to the user (or, analogously, for each of multiple users in the user cohort) while the user is watching videos in the video stream. For example, the video platform can receive an amount corresponding to the selection value for each digital component that is presented to the user in a video stream provided to the user. The amount can be the selection value used to select the digital component for presentation in the content slot in which the digital component was presented, or a value that is equal to or higher than the next highest selection value for a candidate digital component in that selection process. The amount can be a monetary or other amount. The acquired amount can be determined based on the amount for each digital component presented to the user in the video stream. For example, the acquired amount can be the sum of the amounts for the digital components. The acquired amount can be determined for a current session of the user with the video stream.

In some cases, the user interaction data is collected while the digital components are presented to the user in accordance with the same values of the parameters. For example, the user interaction data can be collected while digital components are presented to the user in accordance with previously determined values of the parameters.

Alternatively, in other cases, the user interaction data is collected while digital components are presented to the user in accordance with varying values of the parameters. For example, the user interaction data can be collected while digital components are presented to the user in accordance with randomly selected values of the parameters.

As another example, each parameter can take values within a predetermined range, and the video platform can perform a structured exploration through a possible space of digital component schemes by, for each parameter, starting with the lowest value in the predetermined range, and then gradually increasing the value of the parameter to the highest value in the predetermined range at predetermined time intervals.

Generally, by way of varying the values of the parameters, the video platform performs an exploration through the possible space of the schemes in which digital component can be distributed to collect user interaction data with increased diversity, e.g., that characterizes the different watching experience of the users in the same user cohort under different digital component distribution schemes.

In particular, the video platform automatically determines the updated values of the parameters based on optimizing an objective function of a constrained objective problem. The objective function can include one or more of: a term that is dependent on the watch time (which is collected as part of the user interaction data), a term that is dependent on the acquired amount (which is also collected as part of the user interaction data), or a term that is dependent on both the watch time and the acquired amount.

For example, the objective function can evaluate an expected acquired amount that represents an amount that is expected to be received from the content providers for presentation of digital components to the user assuming that the user will watch videos in the video stream for a certain amount of time. For example, the objective function can be to maximize the acquired amount and long-term user engagement with the video platform for that user.

As an example, the objective function can be defined in the form of:

immediately acquired amount + λ* impact on long-term user engagement,

where the immediately acquired amount is dependent on (e.g., equal to) the selection value of a digital component if it is presented for display, the impact on long-term user engagement is dependent on (e.g., proportional to) the predicted long-term change in user watch time, assuming that the digital component is actually presented for display, and λ is a tunable weighting factor that can be, e.g., between -1 and 1, inclusive on both ends.

Optionally, the objective function can include one or more additional terms. An example of such additional terms is an interruption cost term, which can be multiplied by the total number of digital components being displayed to compute a value to be deducted from an output computed using the objective function mentioned in the example above. The interruption cost score can represent a cost associated with interrupting the video stream with a digital component and can be a specified value for a user, a user cohort, or for all users of the video platform.

The constraint can specify a maximum number of digital components that can be provided to each user for display during a fixed amount of time, e.g., during a minute, ten minutes, or an hour, while the user is watching videos in a video stream. For example, the constraint can be a digital component impression constraint.

As an example, the digital component impression constraint can be defined in the form of a maximum allowable negative impact on long-term user engagement per hour, where the negative impact on long-term user engagement is dependent on (e.g., proportional to) the number of digital components displayed. Generally, the greater the number of digital components being displayed, the greater the negative impact on long-term user engagement.

Such a digital component impression constraint characterizes a negative impact on long-term user engagement caused by the presentation of one or more digital components within the video stream that is being provided for presentation to the user. Generally, the greater the negative impact, the smaller the number of videos that can be provided for presentation to the user, namely, the sooner the video stream will be ended by the user.

To determine the updated values of the parameters, the video platform optimizes the objective function, e.g., maximizes the acquired amount, subject to the constraint(s), e.g., such that the negative impact on long-term user engagement caused by the presentation of one or more digital components is not greater than a predetermined amount, namely, such that the impact on long-term user engagement is not overly negative.

In some implementations where the parameters are parameters included in a function, the video platform can do this by applying a constrained optimization solver to the constrained objective problem. The constrained optimization solver is software that is configured to solve the constrained objective problem by applying suitable optimization techniques. Examples of the suitable optimization techniques include a sequential quadratic programming (SQP) technique and a cross-entropy (CE) technique, to name just a few.

For example, the video platform can provide, as input, data that defines the objective function and the constraint to the constrained optimization solver, e.g., by using an application programming interface (API) offered by the solver, and receive, as output, data that defines the optimal values of the parameters from the solver. The optimal values of the parameters are values of the parameters that, when used to determine the user cost metric for the user which, in turn, governs the presentation of digital components to the user, will optimize the objective function subject to the constraint.

In some other implementations where the parameters are parameters included in a machine learning model, the video platform can do this by applying the user interaction data as training data for the machine learning model, and by using a suitable machine learning training technique, e.g., a backpropagation with gradient descent optimization technique, to repeatedly update the values of the parameters based on optimizing the objective function.

FIG. 6 is a block diagram of an example computer system 600 that can be used to perform operations described above. The system 600 includes a processor 610, a memory 620, a storage device 630, and an input/output device 640. Each of the components 610, 620, 630, and 640 can be interconnected, for example, using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can include, for example, a hard disk device, an optical disk device, a storage device that is shared over a network by multiple computing devices (e.g., a cloud storage device), or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 660. Other implementations, however, can also be used, such as mobile computing devices, mobile communication devices, set-top box television client devices, etc.

Although an example processing system has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing and grid computing infrastructures.

A computer program (also known as a program, software, software application, script, or code) can be written in any suitable form of programming language, including compiled or interpreted languages, declarative or procedural languages, and it can be deployed in any suitable form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, special purpose microprocessors. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

To provide for interaction with a user, embodiments of the subject matter described in this specification can be implemented on a computing device capable of providing information to a user. The information can be provided to a user in any form of sensory format, including visual, auditory, tactile or a combination thereof. The computing device can be coupled to a display device, e.g., an LCD (liquid crystal display) display device, an OLED (organic light emitting diode) display device, another monitor, a head mounted display device, and the like, for displaying information to the user. The computing device can be coupled to an input device. The input device can include a touch screen, keyboard and a pointing device, e.g., a mouse or a trackball, by which the user can provide input to the computing device. Other kinds of devices can be used to provide for interaction with a user as well; for example, feedback provided to the user can be any suitable form of sensory feedback, e.g., visual feedback, auditory feedback, or tactile feedback; and input from the user can be received in any suitable form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any suitable form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Thus, unless explicitly stated otherwise, or unless the knowledge of one of ordinary skill in the art clearly indicates otherwise, any of the features of the embodiments described above can be combined with any of the other features of the embodiments described above.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and/or parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A method performed by one or more computers, the method comprising:
maintaining, for each candidate digital component in a set of candidate digital components, one or more distribution parameters that control eligibility of the digital component to be distributed to client devices for display to users of the client devices;
obtaining, for a user of a video platform, a user cost metric for a particular content slot between two videos in a video stream for presentation to the user, wherein the user cost metric is based on an amount of time since a last digital component was presented to the user in the video stream;
determining, based on the user cost metric and the distribution parameters for one or more of the candidate digital components, to display a candidate digital component in the particular content slot;
selecting, based on the distribution parameters for the one or more candidate digital components, a given candidate digital component; and
sending, to a client device of the user, data that initiates presentation of the given candidate digital component to the user in the particular content slot.

2. The method of claim 1, wherein the user cost metric for the user of the video platform is repeatedly determined for each content slot in the video stream.

3. The method of claim 1, wherein the user cost metric is determined by evaluating an exponential function of time, and the exponential function is based on parameters that include a starting amplitude of the exponential function, a decay rate of the exponential function, and a minimum value of the exponential function.

4. The method of claim 3, wherein the parameters of the exponential function are updated automatically.

5. The method of claim 4, wherein automatically updating the parameters of the exponential function comprises:
determining that a condition for updating the parameters included in the exponential function has been satisfied; and
in response to the determining, automatically updating the parameters based on user interaction data collected since a preceding time point the parameters were updated, wherein the user interaction data comprises, for each of a plurality of users, a respective watch time of the user and a respective acquired amount associated with the user since the preceding time point.

6. The method of claim 5, wherein automatically updating the parameters based on the data comprises determining updated values of parameters based on optimizing an objective function that includes a term dependent on the respective acquired amount by using the data.

7. The method of claim 5 wherein determining that the condition for updating the parameters included in the exponential function has been satisfied comprises determining that a predetermined amount of time has elapsed since the preceding time point the parameters were updated.

8. The method of claim 5, wherein the data is collected while digital components are presented on the client device in accordance varying values of the parameters.

9. The method of claim 8, wherein the varying values comprise randomly selected values.

10. The method of claim 6, wherein the objective function is part of a constrained objective problem that includes a constraint, and wherein optimizing the objective function comprises optimizing the objective function subject to the constraint, the constraint being dependent on a maximum number of digital components that can be provided to each client device for display during a fixed amount of time.

11. The method of claim 4, wherein the values of the parameters correspond to a user cohort, and wherein automatically updating the parameters included in the exponential function further comprises:
updating values of parameters that correspond to another user cohort in parallel with updating the values of the parameters that correspond to the user cohort.

12. A system comprising one or more computers and one or more storage devices storing instructions that are operable, when executed by the one or more computers, to cause the one or more computers to perform operations comprising:
maintaining, for each candidate digital component in a set of candidate digital components, one or more distribution parameters that control eligibility of the digital component to be distributed to client devices for display to users of the client devices;
obtaining, for a user of a video platform, a user cost metric for a particular content slot between two videos in a video stream for presentation to the user, wherein the user cost metric is based on an amount of time since a last digital component was presented to the user in the video stream;
determining, based on the user cost metric and the distribution parameters for one or more of the candidate digital components, to display a candidate digital component in the particular content slot;
selecting, based on the distribution parameters for the one or more candidate digital components, a given candidate digital component; and
sending, to a client device of the user, data that initiates presentation of the given candidate digital component to the user in the particular content slot.

13. The system of claim 12, wherein the user cost metric for the user of the video platform is repeatedly determined for each content slot in the video stream.

14. The system of claim 12, wherein user cost metric is determined by evaluating an exponential function of time, and the exponential function is based on parameters that include a starting amplitude of the exponential function, a decay rate of the exponential function, and a minimum value of the exponential function.

15. The system of claim 14, wherein the parameters of the exponential function are updated automatically.

16. The system of claim 15, wherein automatically updating the parameters of the exponential function comprises:
determining that a condition for updating the parameters included in the exponential function has been satisfied; and
in response to the determining, automatically updating the parameters based on user interaction data collected since a preceding time point the parameters were updated, wherein the user interaction data comprises, for each of a plurality of users, a respective watch time of the user and a respective acquired amount associated with the user since the preceding time point.

17. The system of claim 16, wherein automatically updating the parameters based on the data comprises determining updated values of parameters based on optimizing an objective function that includes a term dependent on the respective acquired amount by using the data.

18. The system of claim 16, wherein determining that the condition for updating the parameters included in the exponential function has been satisfied comprises determining that a predetermined amount of time has elapsed since the preceding time point the parameters were updated.

19. The system of claim 16, wherein the data is collected while digital components are presented on the client device in accordance varying values of the parameters.

20. A non-transitory computer storage medium encoded with a computer program, the program comprising instructions that are operable, when executed by data processing apparatus, to cause the data processing apparatus to perform operations comprising:
maintaining, for each candidate digital component in a set of candidate digital components, one or more distribution parameters that control eligibility of the digital component to be distributed to client devices for display to users of the client devices;
obtaining, for a user of a video platform, a user cost metric for a particular content slot between two videos in a video stream for presentation to the user, wherein the user cost metric is based on an amount of time since a last digital component was presented to the user in the video stream;
determining, based on the user cost metric and the distribution parameters for one or more of the candidate digital components, to display a candidate digital component in the particular content slot;
selecting, based on the distribution parameters for the one or more candidate digital components, a given candidate digital component; and
sending, to a client device of the user, data that initiates presentation of the given candidate digital component to the user in the particular content slot.
